(19) United States
(12) Patent Application Publication
(10) Pub. No.: US 2007/0194990 A1
(43) Pub. Date: Aug. 23, 2007

(54) Monopole antenna for ultrawideband applications

(76) Inventors: Ching-Wei Ling, Taipei (TW); Shyh-Jong Chung, Taipei (TW); Wen Hsin Lo, Taipei (TW)

Correspondence Address: CHRISTIE, PARKER & HALE, LLP, PO BOX 7068, PASADENA, CA, 91109-7068, US

(21) Appl. No.: 11/516,168

(22) Filed: Sep. 5, 2006

Related U.S. Application Data
(60) Provisional application No. 60/713,777, filed on Sep. 2, 2005.

(51) Int. Cl. H01Q 9/04

(52) U.S. Cl. 343/700 MS

(57) ABSTRACT

An ultra wideband antenna includes a substrate, a transmission line coupled to the substrate, and a radiating element coupled to the transmission line at a distance from the substrate and being symmetric about the transmission line. An outer edge of the radiating element has a shape defined by a binomial function.

### RELATED APPLICATIONS

The present application claims the benefit of U.S. Provisional Patent Application Ser. No. 60/713,777, filed Sep. 2, 2005, the contents of which are incorporated by reference herein.

### BACKGROUND

The present application generally relates to antennas, and more particularly, to a planar binomial curved monopole antenna for ultra wideband applications.

Ultrawideband (UWB) communication systems are becoming attractive for high-capacity wireless communication applications. UWB refers to radio communications using transmission of short-duration pulses that occupy a wide bandwidth with very large values. UWB systems typically use a 3.1 GHz to 10.6 GHz frequency band.

A UWB communication device typically includes an antenna, which may be provided on a printed circuit board. The antenna includes a radiation element capable of emitting pulse signals and receiving pulse signals. A variety of antennas are available for UWB applications, including conical antennas, TEM horn antennas, and monopole antennas. Monopole antennas represent a fundamental starting point or building block for most antenna designs. A monopole antenna can be a simpler version of a conical antenna. Monopole antennas are simple in geometry, exhibit good impedance matching, and exhibit stable radiation patterns over bandwidths suitable for UWB applications.

Although a variety of monopole antenna designs are available, it is desirable to have an antenna having a simple shape, which can be parametrically varied during the design stage of the antenna to provide wide impedance bandwidth with stable radiation patterns across bandwidths of interest.

### SUMMARY OF THE INVENTION

In accordance with one aspect of the present disclosure, an ultra wideband antenna includes a substrate, a transmission line coupled to the substrate, and a radiating element coupled to the transmission line at a distance from the substrate and being symmetric about the transmission line. An outer edge of the radiating element preferably has a shape defined by a binomial function.

In accordance with another aspect of the present disclosure, an ultrawideband antenna includes a substrate and a transmitter coupled to the substrate and defining a y-axis. An edge of the substrate intersects the transmission line defining an x-axis. The antenna includes a radiating element coupled to the feed line and spaced from the substrate at a distance G along the y-axis, the radiating element having an outer edge with y-axis coordinates defined by a binomial function of x-axis axis coordinates of the outer edge. The binomial function is defined by:

$$y = f ( x ) = \{ \begin{matrix}G & x = 0 \\ G + {k ( \frac{x}{{x}_{max}} )}^{N} & 0 < x < {x}_{max} \\ G + k & x = {x}_{max}\end{matrix}$$

where k is the length of the radiating element, xₘₐₓ is ½ a width of the radiating element, and N is the order of the binomial function.

### BRIEF DESCRIPTION OF THE DRAWINGS

These and other features, aspects, and advantages of the present invention will become better understood with regard to the following description, appended claims, and accompanying drawings where:

FIG. 1 is a schematic view of an antenna constructed in accordance with the teachings of the present disclosure;

FIG. 2 is a chart showing a simulated return loss for the antenna of FIG. 1 for different values of one parameter defining the shape of the antenna;

FIG. 3 is a chart showing a simulated return loss for the antenna of FIG. 1 for different values of another parameter defining the shape of the antenna;

FIG. 4 is a comparison of a simulated return loss and a measured return loss for the antenna of FIG. 1;

FIG. 5 illustrates radiation patterns in the X-Y, X-Z and Y-Z planes for the antenna of FIG. 1 at 3.1 GHz;

FIG. 6 illustrates radiation patterns in the X-Y, X-Z and Y-Z planes for the antenna of FIG. 1 at 3.5 GHz;

FIG. 7 illustrates radiation patterns in the X-Y, X-Z and Y-Z planes for the antenna of FIG. 1 at 4.0 GHz;

FIG. 8 illustrates radiation patterns in the X-Y, X-Z and Y-Z planes for the antenna of FIG. 1 at 4.5 GHz;

FIG. 9 illustrates radiation patterns in the X-Y, X-Z and Y-Z planes for the antenna of FIG. 1 at 5.0 GHz;

FIG. 10 illustrates radiation patterns in the X-Y, X-Z and Y-Z planes for the antenna of FIG. 1 at 5.5 GHz; and

FIG. 11 illustrates radiation patterns in the X-Y, X-Z and Y-Z planes for the antenna of FIG. 1 at 6.0 GHz.

### DETAILED DESCRIPTION OF THE INVENTION

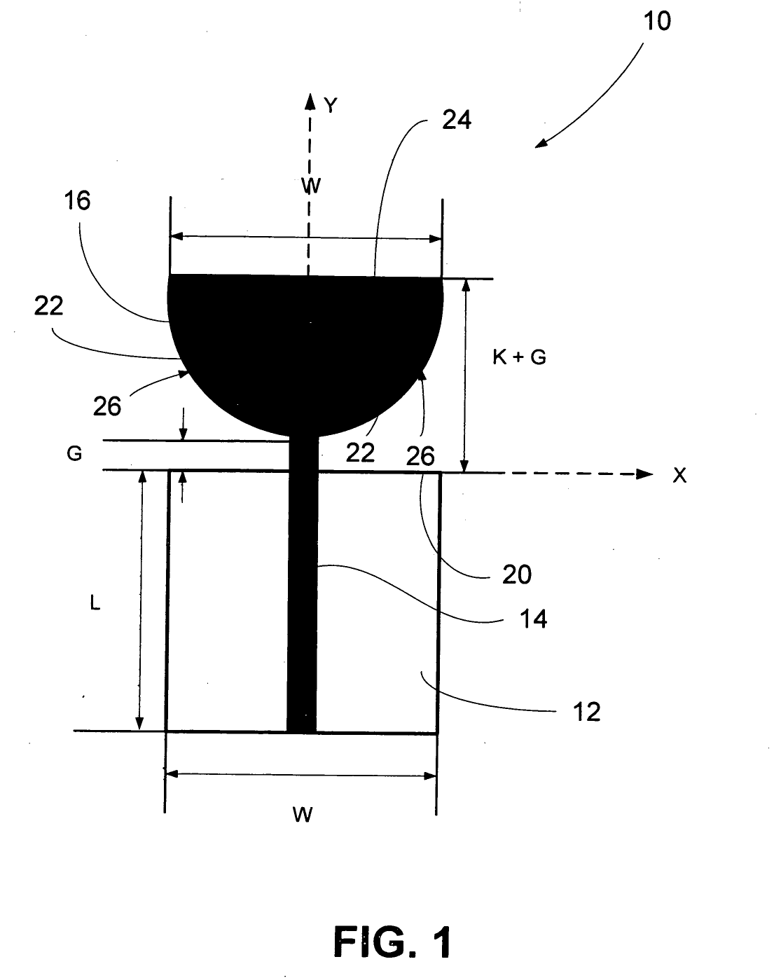

Referring to FIG. 1, an ultra-wideband antenna 10 in accordance with the teachings of the present disclosure is shown. The antenna 10 is on a portion of a substrate 12 having a length L and a width W, a transmission line 14 and a radiating element 16. The substrate 12 may be constructed from a printed circuit board or an FR-4 microwave substrate and forms a ground plane of the antenna 10. The transmission line 14 may be printed on the substrate 12 and can be constructed from copper. In some embodiments, the antenna 10 is printed on a FR4 microwave substrate with a thickness of 0.8 mm and a dielectric constant of 4.4. The transmission line 14 feeds power to the radiating element 16. The transmission line 14 extends beyond the substrate 12 by a distance G. The radiating element 16 is attached or is integral with the transmission line 16 at the distance G from the substrate 12. Both the transmission line 14 and the radiating element 16 can include copper. In most embodiments the transmission line and the radiating element comprise one or more conductive materials.

The length of the transmission line 16 defines a y-axis of the antenna 10. An x-axis of the antenna 10 is defined by an edge 20 the substrate 12 substantially perpendicular to the length of the transmission line, and substantially co-planer with a surface of the substrate. The x-axis and y-axis are arbitrarily defined herein and represent reference axes. Accordingly, the x-axis and y-axis of the antenna 10 can be defined by any other reference coordinates. The radiating element 16 is symmetric about the y-axis and includes two identical halves 22. The radiating element 16 includes an upper edge 24 that is linear and substantially parallel with the edge 20. The radiating element 16 also includes symmetrically opposed side edges 26 relative to the y-axis that are defined by the following binomial function:

$$y = f ( x ) = \{ \begin{matrix}G & x = 0 \\ G + {k ( \frac{x}{{x}_{max}} )}^{N} & 0 < x < {x}_{max} \\ G + k & x = {x}_{max}\end{matrix} \qquad ( 1 )$$

where k is the length of the radiating element 16, xₘₐₓ is ½ the width of the radiating element 16, which is referred to herein by w, and N is the order of the binomial function.

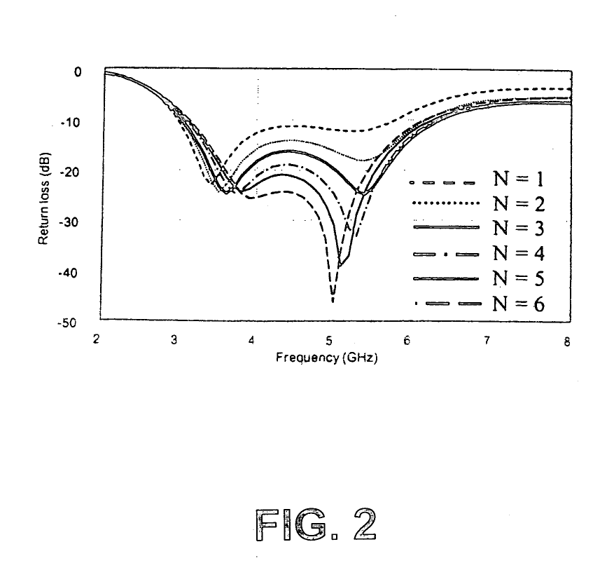

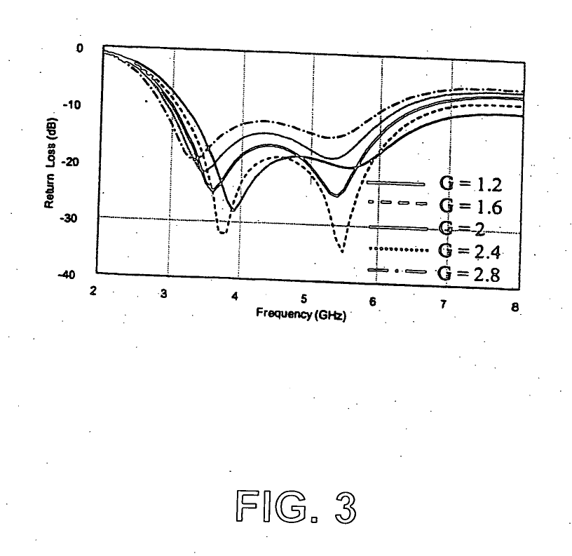

Changing the variables of the above binomial equation can affect the impedance bandwidth of the antenna 10. FIG. 2 shows a simulated return loss for an antenna having an overall size of about 20×32 mm with N varied from 1 to 6. The impedance bandwidths achieved by the antenna 10 can be larger than 3 GHz. The variation in N may affect the upper edge frequency, which is shown by the frequency range from about 5.77 to 6.36 GHz. On the other hand, the variation in N may cause relatively very small effects on the lower-edge frequency, which is shown by the frequency range from about 2.94 to 3.09 GHz. Additionally, the largest impedance bandwidth, which is about 3.36 GHz may be achieved for N=3. Referring to FIG. 3, varying the gap or distance G between the substrate 12 and the radiating element 16 may also affect the impedance bandwidth of the antenna 10. Therefore, the impedance matching of the antenna 10 can be affected by the gap or distance G. The impedance bandwidth ratio of the antenna 10 as used in the experiments described herein reached about 2.01:1 (about 3.09˜6.49 GHz).

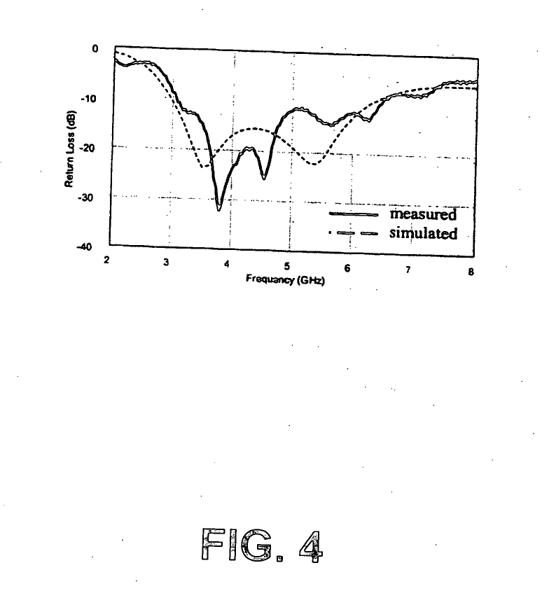

Referring to FIG. 4, measured and simulated return loss of the antenna 10 with N=3 and having an overall size of 20×32 mm are shown. The simulated return losses shown were obtained using the Ansoft simulation software High-Frequency Structure Simulator (HESS™). As shown by FIG. 4, the measured and simulated results are similar. The measured impedance bandwidth, determined by a 10-dB return loss, is from about 3.09 to about 6.49 GHz.

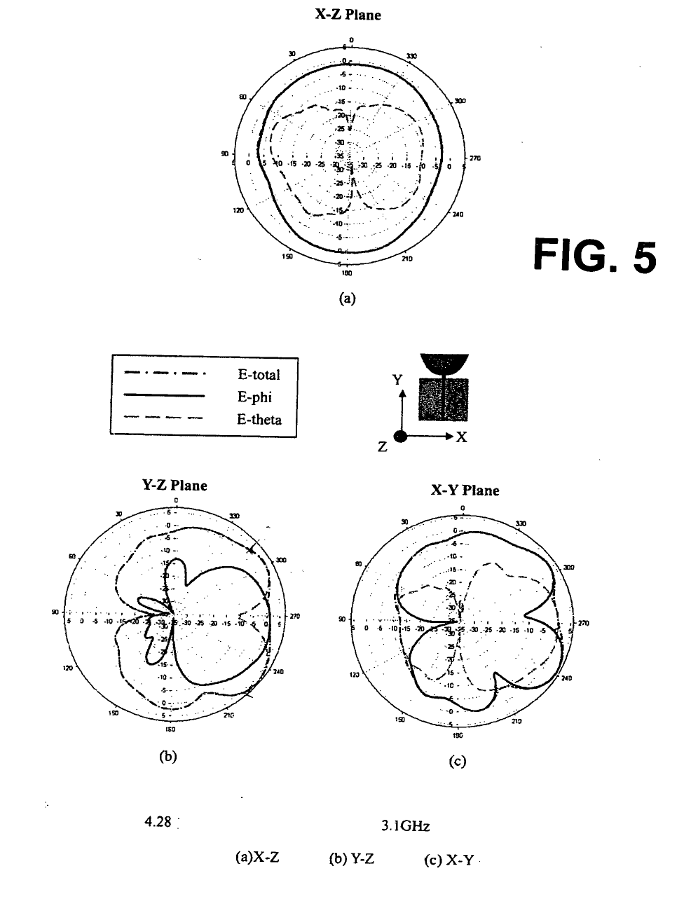

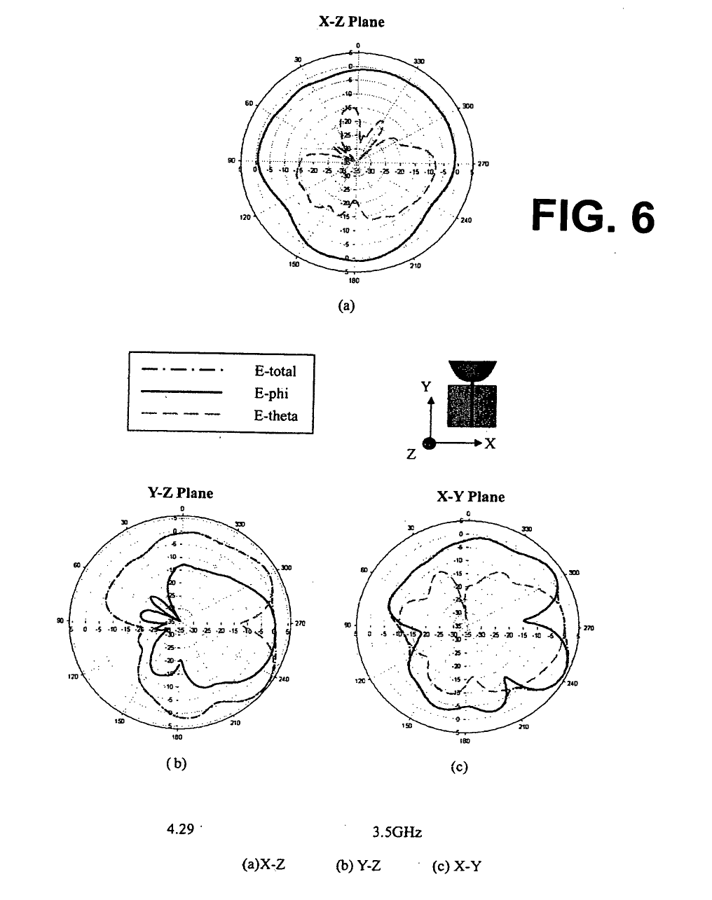

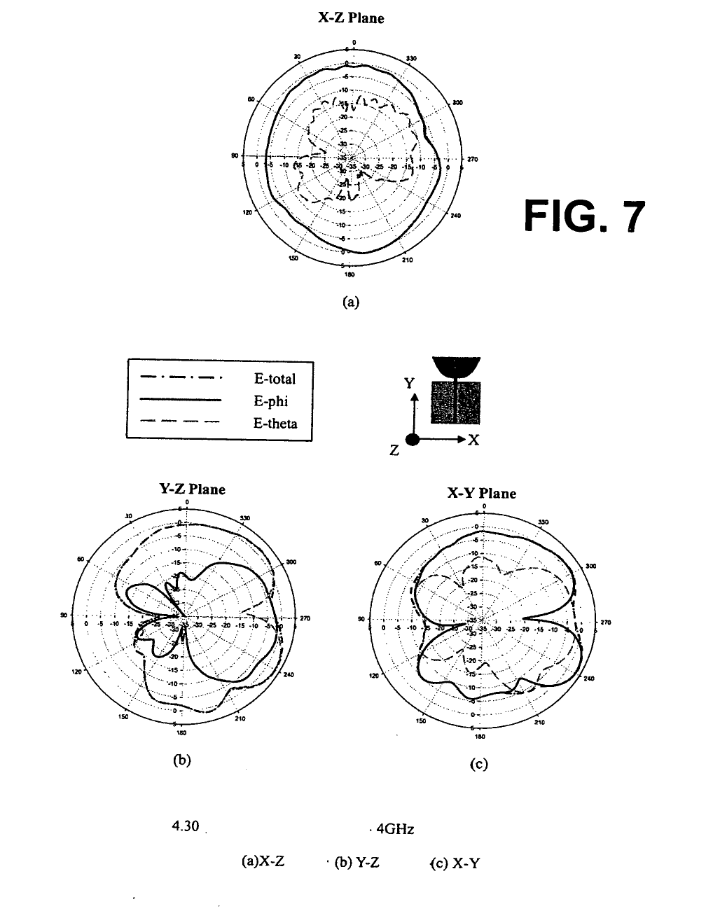

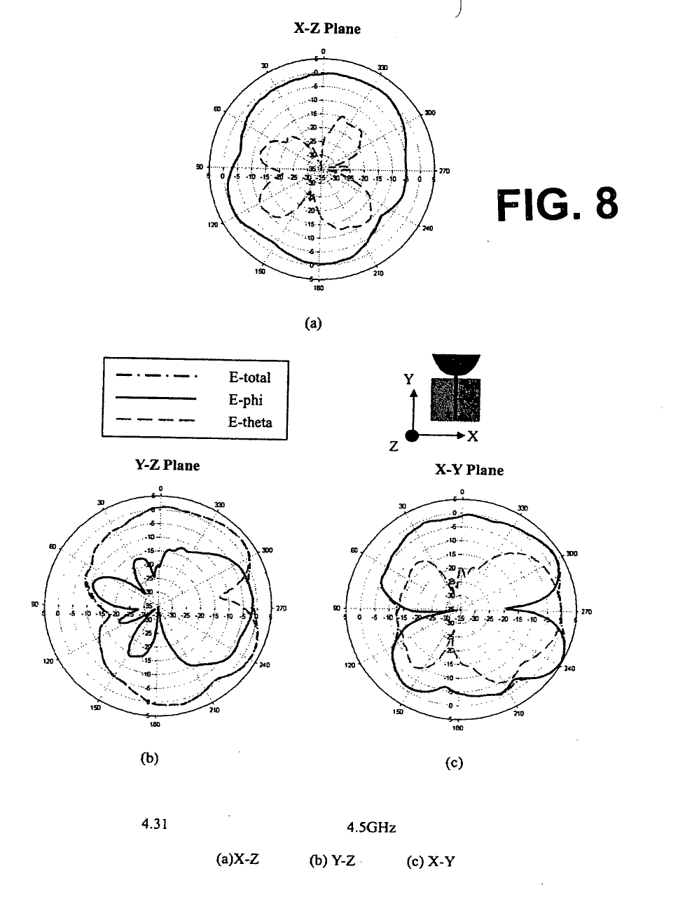

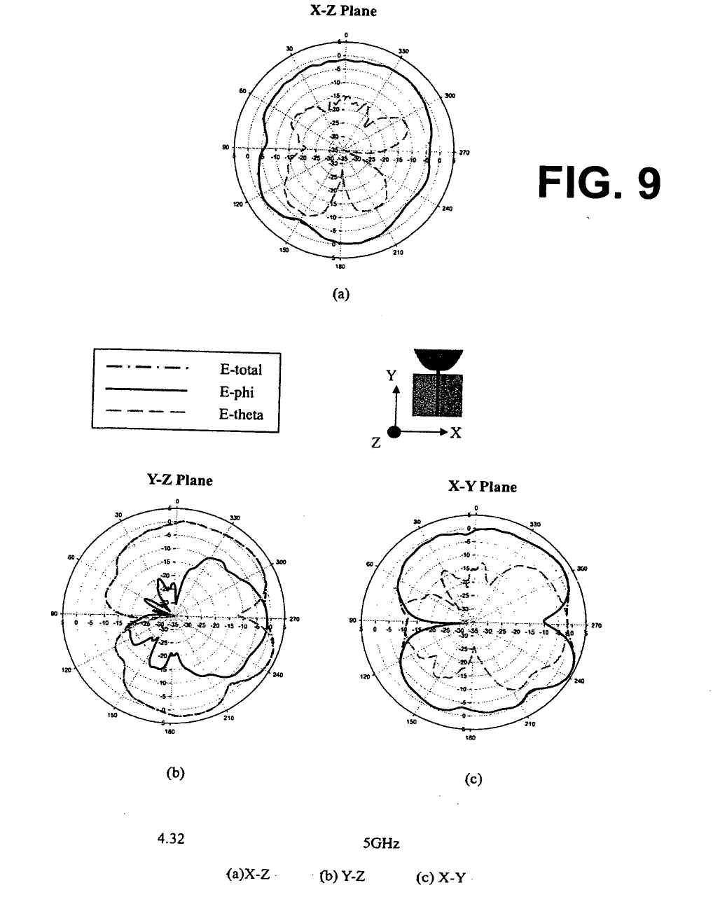

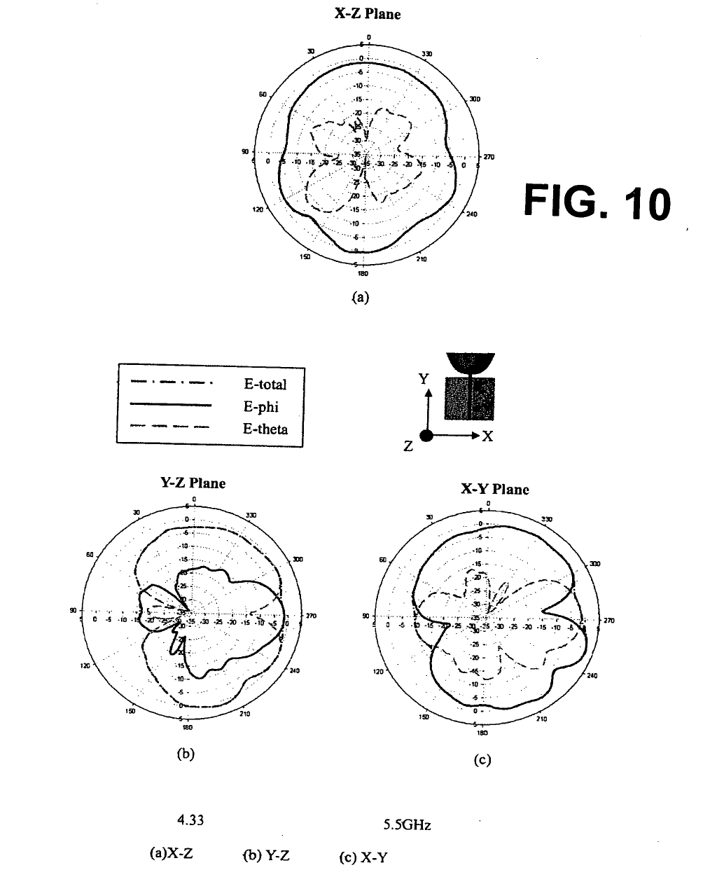

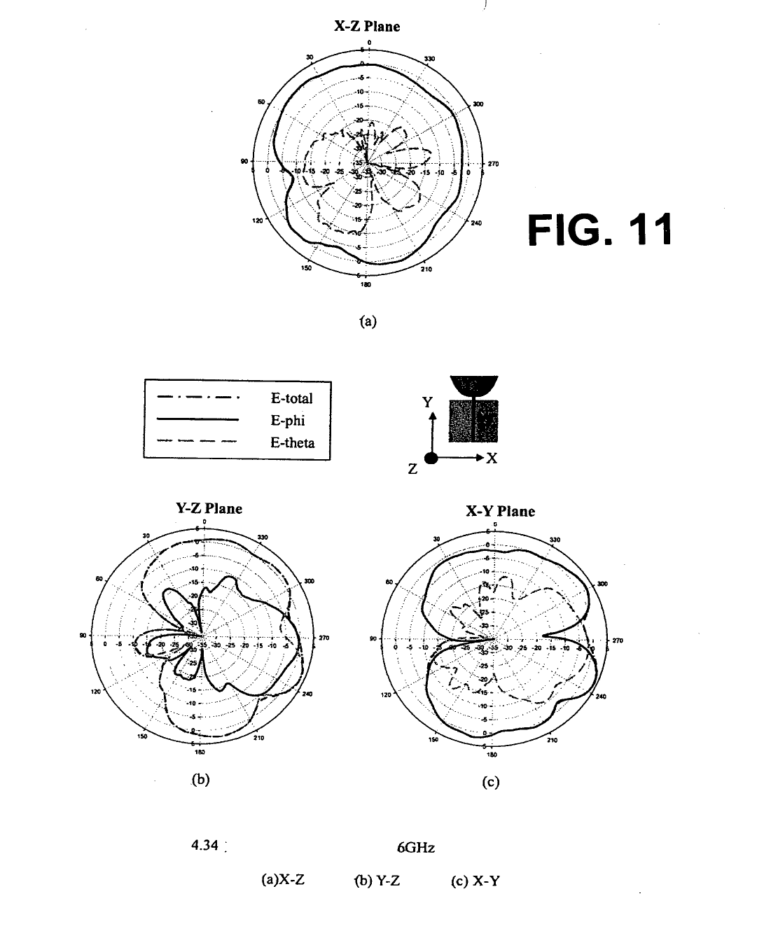

FIGS. 5-11 show plots of radiation patterns of the antenna at different transmission frequencies. Each of the figures include plots of radiation patterns in three orthogonal planes, labeled x-y, x-z, and y-z. The antenna has a length, as previously described, falling along the y-axis and a width, also as previously described, falling along the x-axis. Each of the three plots in each of the FIGS. 5-11 include curves for E-theta, E-phi and E-total. FIG. 5 shows radiation patterns when transmitting with the antenna at a frequency of 3.1 GHz. FIG. 6 shows radiation patterns of the antenna when transmitting with the antenna at the frequency of 3.5 GHz. FIG. 7 shows radiation patterns of the antenna when transmitting with the antenna at the frequency of 4 GHz. FIG. 8 shows radiation patterns of the antenna when transmitting with the antenna at the frequency of 4.5 GHz. FIG. 9 shows radiation patterns of the antenna when transmitting with the antenna at the frequency of 5 GHz. FIG. 10 shows radiation patterns of the antenna when transmitting with the antenna at the frequency of 5.5 GHz. FIG. 11 shows radiation patterns of the antenna when transmitting with the antenna at the frequency of 6 GHz.

For 3.1 GHz, the measured radiation pattern in the x-y plane substantially exhibits omnidirectional radiation. For 6 GHz, a nearly omnidirectional radiation pattern in the x-y plane is also observed. Radiation patterns between 3.1-6 GHz show similar stable omnidirectional radiation patterns.

The antenna 10 of the present disclosure includes a simple structure and can be designed by utilizing a binomial function. As described herein, the impedance bandwidth of the antenna 10 can be varied and may be significantly improved by selecting suitable order N of the binomial function (1), w/2, which is xₘₐₓ in the binomial function (1), and the distance G.

The preceding description has been presented with reference to specific embodiments of the invention shown in the drawings. Workers skilled in the art and technology to which this invention pertains will appreciate that alteration and changes in the described processes and structures can be practiced without departing from the spirit, principles and scope of this invention.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the claims supported by this application and their equivalents rather than the foregoing description.

What is claimed is:

1. An ultra wideband antenna comprising:
a substrate;
a transmission line coupled to the substrate; and
a radiating element coupled to the transmission line at a distance from the substrate and being symmetric about the transmission line, an outer edge of the radiating element having a shape defined by a binomial function.

2. The antenna of claim 1, wherein the binomial function comprises a parameter defining a distance of the radiating element from the substrate.

3. The antenna of claim 1, wherein the binomial function comprises a parameter defining one-half a width of the radiating element.

4. The antenna of claim 1, wherein the binomial function comprises a parameter defining a length of the radiating element.

5. The antenna of claim 1, wherein the radiating element comprises a copper plate.

6. An ultra wideband antenna comprising:
a substrate;
a transmitter coupled to the substrate and defining a y-axis, an edge of the substrate intersecting the transmission line defining an x-axis; and
a radiating element coupled to the feed line and spaced from the substrate at a distance G along the y-axis, the radiating element having an outer edge with y-axis coordinates defined by a binomial function of x-axis coordinates of the outer edge;
wherein the binomial function is defined by
$$y = f ( x ) = \{ \begin{matrix}G & x = 0 \\ G + {k ( \frac{x}{{x}_{max}} )}^{N} & 0 < x < {x}_{max} \\ G + k & x = {x}_{max}\end{matrix}$$
where k is the length of the radiating element, xₘₐₓ is ½ a width of the radiating element, and N is the order of the binomial function.

7. The antenna of claim 6, wherein the radiating element is symmetric about the transmission line.

8. The antenna of claim 6, wherein the radiating element comprises a copper plate.
